(19) United States
(12) Patent Application Publication
(10) Pub. No.: US 2010/0166420 A1
(43) Pub. Date: Jul. 1, 2010

(54) APPARATUS AND METHOD FOR CONTROLLING ROUTE AND RESOURCE IN PACKET-OPTIC CONVERGENCE NETWORK

(75) Inventors: Hyung Seok CHUNG, Daejeon (KR); You Hyeon JEONG, Daejeon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon (KR)

(21) Appl. No.: 12/640,811

(22) Filed: Dec. 17, 2009

(30) Foreign Application Priority Data
Dec. 22, 2008 (KR) 10-2008-0131618
Apr. 8, 2009 (KR) 10-2009-0030243

(51) Int. Cl. H04B 10/08; H04J 14/00

(52) U.S. Cl. 398/9; 398/45

(57) ABSTRACT

There is provided a method of controlling routes and resources in a packet-optic convergence network. The method includes receiving PTL route information between edge devices of the packet-optic convergence network, in which the PTL route information is provided through a route management system; monitoring a resource use state according to PTL route in the process of reserving, changing, or releasing resources in response to a request for the reservation, change, or release of the resources by a service control system; and changing PTL routes or resources allocated to the PTL routes through the route management system on the basis of the resource use state according to PTL route, thereby ensuring greater stability in providing an IP premium service with a Quality of Service (QoS) guarantee.

### CROSS-REFERENCE TO RELATED APPLICATIONS

This application claims the priorities of Korean Patent Application Nos. 10-2008-0131618 filed on Dec. 22, 2008 and 10-2009-0030243 filed on Apr. 8, 2009, in the Korean Intellectual Property Office, the disclosures of which are incorporated herein by reference.

### BACKGROUND OF THE INVENTION

1. Field of the Invention

The present invention relates to a technique for controlling routes and resources in a packet-optic convergence network, and more particularly, to a method of controlling routes and resources in a packet-optic convergence network that dynamically changes routes and resources to ensure greater stability in providing an IP premium service with a Quality of Service (QoS) guarantee.

2. Description of the Related Art

A packet-optic convergence network incorporates Packet-Optical Integrated Network Transport Switch (POINTS) devices, which is called a next generation network including Layer 0 to Layer 4.

The POINTS devices use a Packet Transport Layer (PTL) tunneling technique for transporting Layer 1.5. The PTL tunneling technique may be similar to an L2 tunneling technique of an existing PBB-TE or MPLS-PE. However, the transport mechanism of the PTL tunneling technique does not transport IP packets through a tunnel; rather, it transports only IP premium service traffic through a PTL route by differentiating service session flows.

A network operator sets an optical path of Layer 0 and Layer 1 between the POINTS devices, and then sets the PTL route thereon.

The PTL route is a logical route in which the bandwidth resources of the optical path are dividedly defined, and it is set between edge-to-edge devices of the packet-optic convergence network. The PTL route ensures a QoS guarantee of the IP premium service traffic. In the same edge-to-edge section, multiple PTL routes may be set according to service.

Since there are various QoS requirements according to types of IP premium service, PTL routes satisfying the corresponding QoS requirements are set separately. Such a separate setting allows various service session flows to be transmitted through an appropriate PTL route.

Up until now, however, a technique for controlling routes and resources to guarantee the QoS of IP premium service traffic has not yet been proposed.

Meanwhile, a next generation network (NGN) or a broadband communications network (BcN) provides a dynamic resource admission control function on the basis of the preset standard of ITU-T Resource Access Control Facility (RACF).

An RACF system determines whether to use resources for an IP service session on the basis of network routes and resources previously allocated by a network management station (NMS) or a provisioning server. In case of a lack of resources in a route (hereinafter referred to as “route resources”) that can provide a QoS guarantee of service session traffic, a resource reservation for the corresponding service session is rejected.

In the case that the number of rejections of a reservation for particular route resources increases, it is difficult to provide a stable service. In this case, the network operator has to properly take action by continuously checking the resource use state of the route.

That is, the RACF system, which has been developed up until now, determines admission or rejection as to whether to use resources in response to a resource reservation request for a service session within the limit of route resources that the network operator sets through a additional route setting system.

In RACF systems according to the related art, the route resources cannot be automatically changeable after being allocated. This causes inconvenience in that the network operator has to check the resource use state and manually change the route resources.

### SUMMARY OF THE INVENTION

An aspect of the present invention provides a method of controlling routes and resources in a packet-optic convergence network in a manner that automatically controls Packet Transport Layer (PTL) routes and resources without a network operator's intervention so that a Quality of Service (QoS) guarantee of IP premium service traffic is stably achieved.

According to an aspect of the present invention, there is provided a method of controlling routes and resources in a resource admission control system included in a packet-optic convergence network, the method including: monitoring a resource use state according to Packet Transport Layer (PTL) route in the process of reserving, changing, or releasing resources in response to a request of a service control system; and changing PTL routes or resources allocated to the PTL routes through a route management system on the basis of the resource use state according to PTL route.

Also, the method further includes receiving PTL route information between edge devices of the packet-optic convergence network, the PTL route information being provided through the route management system.

The monitoring of the resource use state includes: monitoring a resource of a PTL route corresponding to a particular service session on the basis of the PTL route information, when the service control system makes a request for reservation, change, or release of resources for the particular service session; and monitoring the resource use state in the process of reserving, changing, or releasing the resources on the basis of the monitored resource of the corresponding PTL route.

The changing of the PTL routes or the resources allocated to the PTL routes through the route management system includes: increasing an amount of allocated resources for a PTL route having a large amount of resources relative to a resource use rate thereof; decreasing the amount of allocated resources for a PTL route having a small amount of resources relative to a resource use rate thereof; canceling a PTL route having a resource use rate below a preset standard; and additionally setting a PTL route having a resource use rate above the preset standard.

According to another aspect of the present invention, there is provided a method of controlling routes and resources in a route management system included in a packet-optic convergence network, the method including: setting Packet Transport Layer (PTL) routes between edge devices of the packet-optic convergence network and allocating resources to the PTL routes, and providing PTL route information to a resource admission control system; and changing the PTL routes or the resources allocated to the PTL routes in response to a resource change request of the resource admission control system.

Also, the method further includes reporting, to the resource admission control system, a result of the changing of the PTL routes or the resources allocated to the PTL routes.

According to still another aspect of the present invention, there is provided an apparatus of controlling routes and resources in a packet-optic convergence network, the apparatus including: a route management system setting Packet Transport Layer (PTL) routes and allocating resources to the PTL routes; and a resource admission control system reserving, changing, or releasing the resources in response to a request of a service control system, and then changing the PTL routes or the resources allocated to the PTL routes through the route management system on the basis of a resource use state according to PTL route.

The route management system changes the PTL routes or the resources allocated to the PTL routes in response to the request of the service control system, and reports, to the resource admission control system, a result of the changing of the PTL routes or the resources allocated to the PTL routes.

The resource admission control system causes the route management system to increase an amount of allocated resources for a PTL route having a large amount of resources relative to a resource use rate thereof, decrease the amount of allocated resources for a PTL route having a small amount of resources relative to a resource use rate thereof, cancel a PTL route having a resource use rate below a preset standard, and additionally set a PTL route having a resource use rate above the preset standard.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a configuration for an apparatus for controlling routes and resources in a packet-optic convergence network according to an exemplary embodiment of the present invention; and

FIG. 2 is a flowchart illustrating a method of controlling resources in a packet-optic convergence network according to an exemplary embodiment of the present invention.

### DETAILED DESCRIPTION OF THE PREFERRED EMBODIMENT

Exemplary embodiments of the present invention will now be described in detail with reference to the accompanying drawings. However, detailed descriptions related to well-known functions or configurations will be ruled out in order not to unnecessarily obscure subject matters of the present invention.

Throughout the drawings, the parts beyond the descriptions will be omitted for clarity, and the same reference numerals will be used to designate the same or like parts.

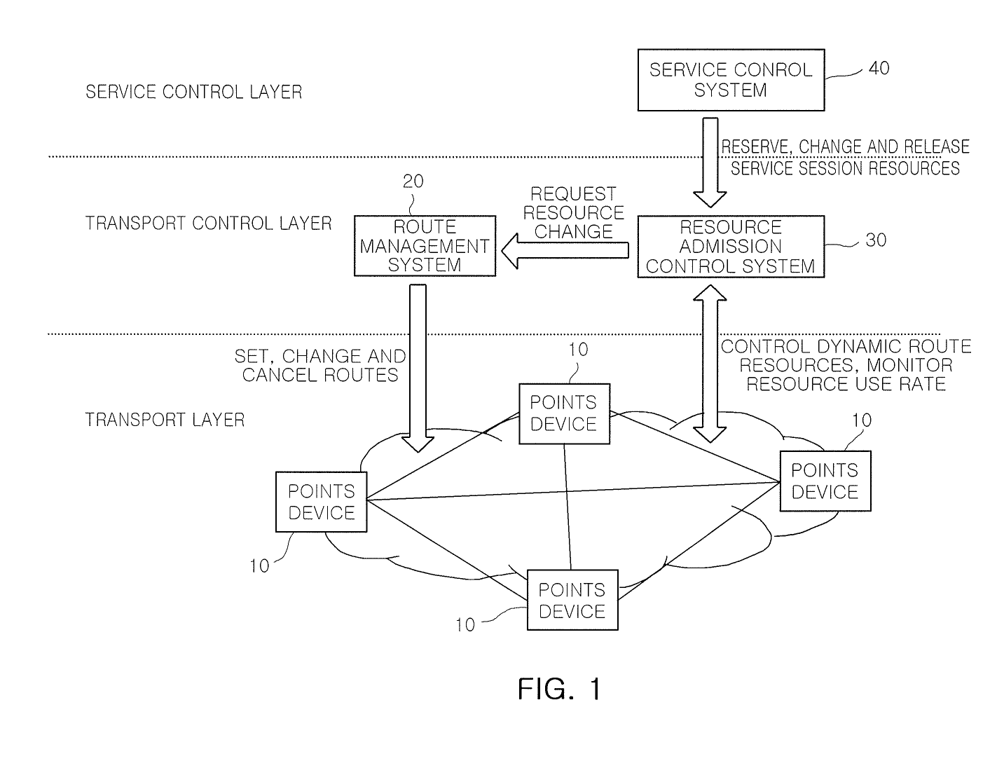

FIG. 1 illustrates a configuration for an apparatus for controlling routes and resources in a packet-optic convergence network according to an exemplary embodiment of the present invention.

Referring to FIG. 1, an apparatus for controlling routes and resources in a packet-optic convergence network includes Packet-Optical Integrated Network Transport Switch (POINTS) devices 10, a route management system 20, a resource admission control system 30, and a service control system 40.

The POINTS devices 10 are edge devices constituting the packet-optic convergence network, and both optical paths of Layer 0 and Layer 1 and Packet Transport Layer (PTL) route. And, the POINTS devices 10 guarantee a QoS of IP premium service traffic through the PTL route.

The route management system 20 sets the optical paths and the PTL route between the POINTS devices 10 and allocates resources such as bandwidth according to route and tunnel. In response to a resource change request of the resource admission control system 30, the route management system 20 additionally sets or cancels a particular PTL route, and increases or decreases the resources allocated to the particular PTL route.

The resource admission control system 30 collects PTL route information through the route management system 20 and processes a request for reservation, change, or release of resources for a service session (service session resources) by the service control system 40 like a 3GPP IMS on the basis of the collected PTL route information. Here, the PTL route information includes an edge-to-edge device address according to PTL route, route bandwidth, and an IP subnet address allocated to the route.

Also, the resource admission control system 30 periodically monitors a resource use state for all PTL routes and analyzes a resource use state according to PTL route. The resource admission control system 30 requests the route management system 20 to change resources on the basis of PTL route resource use statistical information analyzed over a period of time, and then updates the PTL route information on the basis of the results of resource change process performed by the route management system 20.

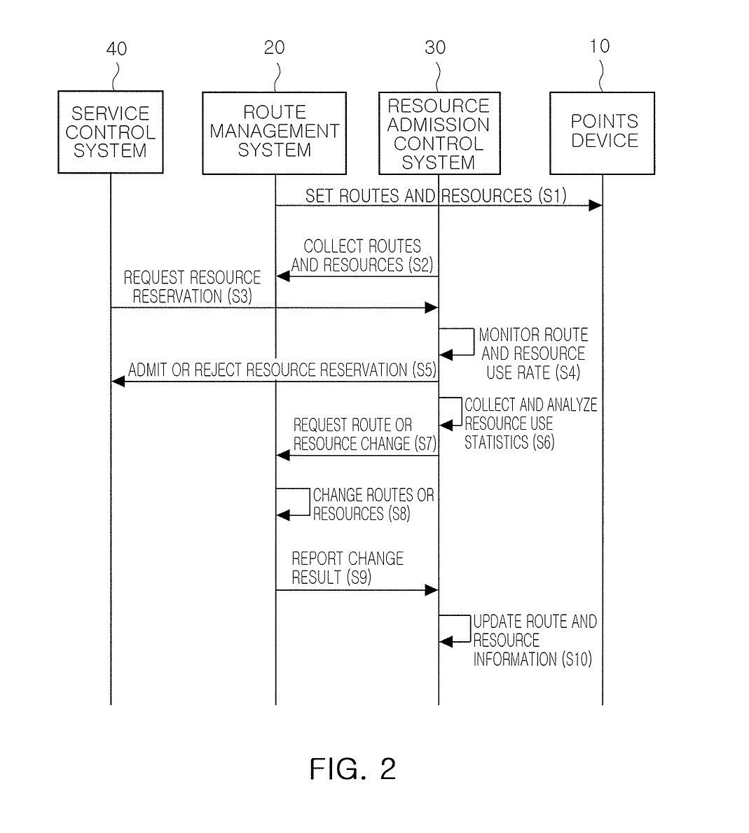

FIG. 2 is a flowchart illustrating a method of controlling resources in a packet-optic convergence network according to an exemplary embodiment of the present invention.

The route management system 20 performs an initial process by setting an optical path and a PTL route between the POINTS devices constituting the packet-optic convergence network and allocating resources to all network routes in operation S1.

After the initial process of operation S1 is successfully completed, the resource admission control system 30 collects PTL route information that is provided through the route management system 20 in operation S2.

If the service control system 40 requests a resource reservation in order to provide a service session such as IPTV,

VoIP, and VoD in operation S3, the resource admission control system 30 determines a PTL route capable of guaranteeing the QoS of the corresponding service session on the basis of the PTL route information and monitors the resources of the PTL route in operation S4. If the resources of the corresponding

PTL route are sufficient, the resource reservation for the corresponding service session is admitted in operation S5, and if not, the resource reservation is rejected in operation S5.

During operations S4 and S5, the resource admission control system 30 periodically monitors a resource use state for all of the PTL routes, and then collects and analyzes PTL route resource use statistical information in operation S6.

As a result of operation S6, if the number of resource reservation rejections due to lack of resources of a particular PTL route increases above a preset standard, the resource admission control system 30 requests the route management system 20 to allocate more resources to the corresponding PTL route and allocate reduced resources to a PTL route having a low resource use rate in operation S7. Also, the resource admission control system 30 requests a cancellation of a PTL route having a resource use rate below the preset standard over a period of time, while it requests an additional setting of a PTL route having a resource use rate above the preset standard in operation S7.

In response to the resource change request of the resource admission control system 30, the route management system 20 increases or decreases the resources allocated to the particular PTL route, or performs the resource change process such as addition and cancellation of the particular PTL route in operation S8, and then reports the results of the resource change process to the resource admission control system 30 in operation S9.

The resource admission control system 30 updates the PTL route information on the basis of the results of the resource change process such that the next resource admission control can be performed on the basis of the updated PTL route information in operation S10.

As set forth above, according to exemplary embodiments of the present invention, the apparatus for controlling the routes and the resources in the packet-optic convergence network is able to periodically monitor the resource use state for all of the PTL routes and automatically control the PTL routes and resources, according to the results of monitoring, without the network operator's intervention. Consequently, it is possible to transport IP premium service traffic with a consistent QoS guarantee, not having delays or interruptions caused by changing the routes and the resources.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of controlling routes and resources in a resource admission control system included in a packet-optic convergence network, the method comprising:
Monitoring a resource use state according to Packet Transport Layer (PTL) route in the process of reserving, changing, or releasing resources in response to a request of a service control system; and
changing PTL routes or resources allocated to the PTL routes through a route management system on the basis of the resource use state according to PTL route.

2. The method of claim 1, further comprising:
receiving PTL route information between edge devices of the packet-optic convergence network, the PTL route information being provided through the route management system.

3. The method of claim 2, wherein the monitoring of the resource use state comprises:
monitoring a resource of a PTL route corresponding to a particular service session on the basis of the PTL route information, when the service control system makes a request for reservation, change, or release of resources for the particular service session; and
monitoring the resource use state in the process of reserving, changing, or releasing the resources on the basis of the monitored resource of the corresponding PTL route.

4. The method of claim 2, wherein the changing of the PTL routes or the resources allocated to the PTL routes through the route management system comprises:
increasing an amount of allocated resources for a PTL route having a large amount of resources relative to a resource use rate thereof;
decreasing the amount of allocated resources for a PTL route having a small amount of resources relative to a resource use rate thereof;
canceling a PTL route having a resource use rate below a preset standard; and
additionally setting a PTL route having a resource use rate above the preset standard.

5. The method of claim 4, further comprising updating the PTL route information on the basis of a result of the changing of the PTL routes or the resources allocated to the PTL routes through the route management system.

6. A method of controlling routes and resources in a route management system included in a packet-optic convergence network, the method comprising:
setting Packet Transport Layer (PTL) routes between edge devices of the packet-optic convergence network and allocating resources to the PTL routes, and providing PTL route information to a resource admission control system; and
changing the PTL routes or the resources allocated to the PTL routes in response to a resource change request of the resource admission control system.

7. The method of claim 6, further comprising reporting, to the resource admission control system, a result of the changing of the PTL routes or the resources allocated to the PTL routes.

8. An apparatus of controlling routes and resources in a packet-optic convergence network, the apparatus comprising:
a route management system setting Packet Transport Layer (PTL) routes and allocating resources to the PTL routes; and
a resource admission control system reserving, changing, or releasing the resources in response to a request of a service control system, and then changing the PTL routes or the resources allocated to the PTL routes through the route management system on the basis of a resource use state according to PTL route.

9. The apparatus of claim 8, wherein the route management system changes the PTL routes or the resources allocated to the PTL routes in response to the request of the service control system, and reports, to the resource admission control system, a result of the changing of the PTL routes or the resources allocated to the PTL routes.

10. The apparatus of claim 8, wherein the resource admission control system causes the route management system to increase an amount of allocated resources for a PTL route having a large amount of resources relative to a resource use rate thereof, decrease the amount of allocated resources for a PTL route having a small amount of resources relative to a resource use rate thereof, cancel a PTL route having a resource use rate below a preset standard, and additionally set a PTL route having a resource use rate above the preset standard.
